(19) United States
(12) Patent Application Publication
(10) Pub. No.: US 2020/0160727 A1
(43) Pub. Date: May 21, 2020

(54) METHOD FOR DETERMINING FLIGHT POLICY OF UNMANNED AERIAL VEHICLE, UNMANNED AERIAL VEHICLE AND GROUND DEVICE

(71) Applicant: SZ DJI TECHNOLOGY CO., LTD., Shenzhen (CN)

(72) Inventors: Chang GENG, Shenzhen (CN); Hongzhu ZHOU, Shenzhen (CN); Shu WANG, Shenzhen (CN)

(21) Appl. No.: 16/740,875

(22) Filed: Jan. 13, 2020

Related U.S. Application Data
(63) Continuation of application No. PCT/CN2017/095306, filed on Jul. 31, 2017.

(51) Int. Cl. G08G 5/00; G05D 1/10; G05D 1/00; G06K 9/00; B64C 39/02

(52) U.S. Cl. CPC G08G 5/006; G05D 1/106; G08G 5/003; B64C 2201/12; G06K 9/0063; B64C 39/024; G05D 1/0022

(57) ABSTRACT

A method for determining a flight strategy of an unmanned aerial vehicle includes determining a position of a ground device communicating with the unmanned aerial vehicle; determining a first flight state of the unmanned aerial vehicle according to the position of the ground device and a flight-restriction zone; and determining a scene of the unmanned aerial vehicle and the flight strategy corresponding to the scene according to the first flight state of the unmanned aerial vehicle.

### CROSS-REFERENCE TO RELATED APPLICATION

This application is a continuation of International Patent Application No. PCT/CN2017/095306, filed on Jul. 31, 2017, the entire content of which is incorporated herein by reference.

### TECHNICAL FIELD

The present disclosure relates to the field of control technology and, more particularly, to a method for determining a flight policy of an unmanned aerial vehicle, an unmanned aerial vehicle, and a ground device.

### BACKGROUND

Unmanned aerial vehicles (UAVs) may enter a flight-restriction zone during flight, and if a UAV does not fly in accordance with regulations, flight safety of the UAV and other aircrafts may be affected. Therefore, it is necessary to restrict flight of UAVs. Currently, before a UAV performs a flight restriction, it is necessary to confirm whether a position of the UAV is in a flight-restriction zone. When the UAV is in a flight-restriction zone, a flight restriction is performed.

A position of a UAV can be obtained using a global positioning system (GPS) device. However, the GPS device of the UAV is vulnerable to interference, resulting in inaccurate positioning. For example, in a low-altitude environment in a city, satellite search of a GPS device in a UAV (i.e., the GPS device establishing communication with a satellite) is often slow or even not achievable. Thus, the UAV has no position information when it takes off, and only after the UAV flies to a certain height, the position is detected and position information appears. During the above-described process, it may occur that the UAV is already in a flight-restriction zone when taking off, and immediately after the takeoff, flight restriction is performed, or the UAV is forced to land. Further, if GPS signals are lost, the UAV continues to fly. The UAV repeats such processes and, thus, the UAV may be lost or crashed, affecting user operation experience.

### SUMMARY

In accordance with the disclosure, there is provided a method for determining a flight strategy of an unmanned aerial vehicle. The method includes determining a position of a ground device communicating with the unmanned aerial vehicle; determining a first flight state of the unmanned aerial vehicle according to the position of the ground device and a flight-restriction zone; and determining a scene of the unmanned aerial vehicle and the flight strategy corresponding to the scene according to the first flight state of the unmanned aerial vehicle.

Also in accordance with the disclosure, there is provided an electronic device. The electronic device includes a memory and a processor. The memory stores one or more instructions. The processor is configured to read the one or more instructions from the memory and execute the one or more instructions to perform: determining a position of a ground device communicating with an unmanned aerial vehicle; determining a first flight state of the unmanned aerial vehicle according to the position of the ground device and a flight-restriction zone; and determining a scene of the unmanned aerial vehicle and a flight strategy corresponding to the scene according to the first flight state of the unmanned aerial vehicle.

### BRIEF DESCRIPTION OF THE DRAWINGS

In order to explain the technical solutions of the present disclosure, the accompanying drawings used in the descriptions of embodiments are briefly introduced below. The accompanying drawings in the following descriptions are merely some of the embodiments of the present disclosure. Other drawings derived by those having ordinary skills in the art on the basis of the described drawings without inventive efforts should fall within the scope of the present disclosure.

FIG. 1 illustrates a flowchart of a method for determining a flight strategy of an unmanned aerial vehicle (UAV) according to various embodiments of the present disclosure;

FIG. 2 illustrates another flowchart of a method for determining a flight strategy of a UAV according to various embodiments of the present disclosure;

FIG. 3 illustrates another flowchart of a method for determining a flight strategy of a UAV according to various embodiments of the present disclosure;

FIG. 4 illustrates switching of flight states of a UAV according to various embodiments of the present disclosure;

FIG. 5 illustrates a schematic structural diagram of a UAV according to various embodiments of the present disclosure; and

FIG. 6 illustrates a schematic structural diagram of a ground device according to various embodiments of the present disclosure.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments derived by those of ordinary skills in the art on the basis of the described embodiments without inventive efforts should fall within the scope of the present disclosure.

Exemplary embodiments will be described with reference to the accompanying drawings, in which the same reference numbers refer to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure. The term “and/or” used herein includes any suitable combination of one or more related items listed.

When a positioning device of a UAV is interfered, e.g., when no satellite signal is detected, there is no position information at such time. According to an existing flight policy, i.e., according to an existing flight strategy, the UAV takes off normally. After the UAV flies to a certain height, the positioning device establishes communication with a satellite to determine a current position. If the current position is in a flight-restriction zone, the UAV performs flight restriction or forced landing. Further, if there is no position information, the UAV continues to fly again. The UAV repeats such processes, causing the UAV to be lost or crashed.

Directed to solving the above-described technical issues, the present disclosure provides a method for determining a flight policy, i.e., a flight strategy, of a UAV. In some embodiments, a position of a ground device may be used to determine a first flight state of the UAV, and a scene which the UAV is in, also referred to as a “scene of the UAV,” may be determined according to the first flight state, and further a flight strategy of the UAV may be determined according to the scene. In the present disclosure, the position of the ground device may be used to prevent a situation that a position is not collected because a positioning device of the UAV cannot collect the position, and to prevent the UAV from being lost or from entering a flight-restriction zone, improving user experience. In some embodiments, the ground device may be, for example, a terminal device for controlling the flight of the UAV, such as a remote controller. In some embodiments, the ground device may be, for example, a terminal device having an application program (APP) for controlling the UAV, such as a mobile phone, a smartphone, a tablet computer, a laptop computer, a ground station, a wearable device, e.g., a watch or a bracelet, etc.

In some embodiments, a flight state of the UAV may be determined according to a position of the ground device and/or a position of the UAV, and further, a scene of the UAV may be determined according to the flight state of the UAV, and further, a flight strategy of the UAV may be determined according to the scene of the UAV.

In some embodiments, the position of the ground device may be used to indicate a position relationship between the ground device and a flight-restriction zone, and the position of the UAV may be used to indicate a position relationship between the UAV and a flight-restriction zone. In some embodiments, the flight-restriction zone may include, for example, a no-flight zone and a height-restriction zone. The no-flight zone may refer to a space region extending from the ground toward the sky. The height-restriction zone may refer to a space region extending toward the sky from a position at a preset distance from the ground, and may be considered as, for example, a no-flight zone that is suspended in the air. In some embodiments, data of the flight-restriction zone may be configured in the UAV in advance. In some embodiments, data of the flight-restriction zone may be obtained by the UAV via a network, such as a 4G network or the Internet. Since the flight-restriction zone may include, for example, the no-flight zone and the height-restriction zone, the position relationship with the flight-restriction zone may include at least one of: an in-no-flight-zone position, an outside-no-flight-zone position, an in-height-restriction-zone position, an outside-height-restriction-zone position, or an unknown position.

In some embodiments, a flight state of the UAV may be used to indicate a corresponding safety level of the UAV. For example, the flight state of the UAV may include at least one of: a dangerous state (i.e., a confirmed-dangerous state), a safe state, a safe-and-height-restriction state, a partially-safe state, a partially-safe-and-height-restriction state, or an unknown state.

In some embodiments, the scene of the UAV may be used to indicate an inferred position of the UAV and an inferred current state of a satellite signal of the UAV. For example, the scene of the UAV may include at least one of: a confirmed-in-no-flight-zone (CINFZ) scene, a suspected-in-no-flight-zone-lost-satellite-signal (SINFZLSS) scene, a confirmed-in-height-restriction-zone (CIHRZ) scene, a suspected-in-height-restriction-zone-lost-satellite-signal (SIHRZLSS) scene, a confirmed-outside-no-flight-zone (CONFZ) scene, or a lost-satellite-signal (LSS) scene.

In some embodiments, when the scene of the UAV is determined according to a flight state of the UAV, the scene of the UAV may be determined according to a current flight state of the UAV. In some embodiments, a current state of the UAV may be detected and recorded every certain time period. In some embodiments, the scene of the UAV may be determined according to the current flight state of the UAV and last N recorded flight states of the UAV, where N may be, for example, 1 or an integer greater than 1. Further, there are no limitations on how to obtain flight states of the UAV.

In some embodiments, flight strategies corresponding to different scenes may be preset in the UAV. After determining the scene of the UAV, a flight strategy corresponding to the scene may be performed.

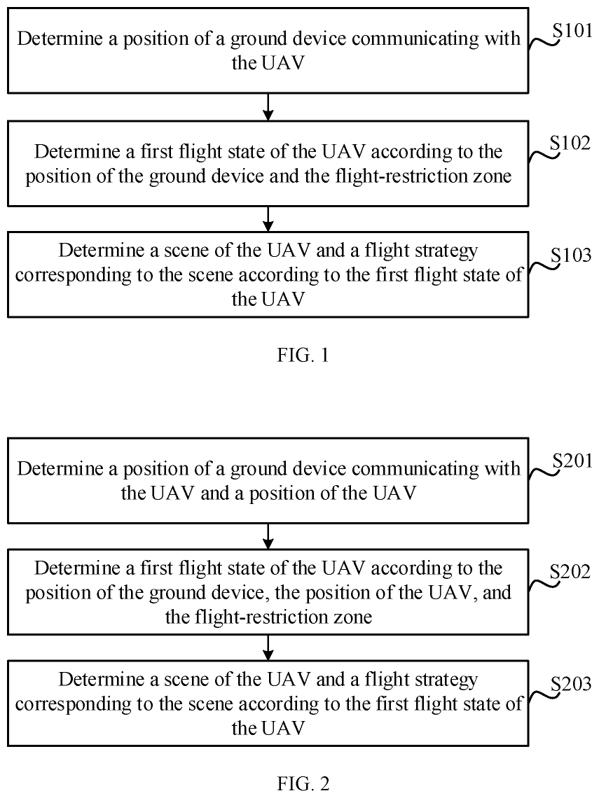

FIG. 1 illustrates a flowchart of a method for determining a flight strategy of a UAV according to various embodiments of the present disclosure. Referring to FIG. 1, the method can be applied to a UAV and/or a ground device. Taking the application of the method on a UAV as an example, the method may include S101 to S103.

In S101, a position of a ground device communicating with the UAV is determined.

In some embodiments, the ground device may be, for example, a control-terminal device or a terminal device having an APP thereon for controlling the UAV.

For example, when the ground device is a control-terminal device, the control-terminal device may communicate with the UAV, and sends its own position to the UAV via the communication connection.

As another example, when the control-terminal device cannot obtain its own position, the control-terminal device may read a position of a smart-terminal device connected to the control-terminal device, such as a mobile phone, and may take the position of the smart-terminal device as the position of the control-terminal device. Under normal circumstances, a distance between the smart-terminal device and the control-terminal device carried by a user is not too far. For example, the distance may be from several meters to approximately tens of meters. Thus, the solution is feasible. The control-terminal device may further send position information to the UAV.

As another example, when the ground device is a terminal device having an APP configured thereon for controlling the UAV, the APP may read the position information obtained by the terminal device and further send the position information to the UAV via a communication connection.

In some embodiments, the ground device may send UAV position information, e.g., position data, in a format required by the UAV. In some other embodiments, the UAV may analyze the position information to obtain the required format, and further determine the position of the ground device. In the present disclosure, the manner of how UAV obtains position information in the required format is not limited.

For ease of understanding, the position of the ground device is referred to as a “first position” in the present disclosure.

It should be understood that generally the first position may be obtained not by using a GPS positioning device, but by using an existing mobile communication, such as a second-generation (2G) network, a third-generation (3G) network, a fourth-generation (4G) network, etc. Since a probability of interference with mobile communication is very small, in the present disclosure, accuracy of the first position may be much higher than accuracy of a position obtained by the positioning device mounted on the UAV.

In S102, a first flight state of the UAV is determined according to the position of the ground device and the flight-restriction zone.

In some embodiments, the flight-restriction zone may include, for example, a no-flight zone and a height-restriction zone. The no-flight zone may refer to a space region extending from the ground to the sky. The height-restriction zone may refer to a space region that extends to the sky from a position at a preset distance from the ground, and may be considered as, for example, a suspended no-flight zone that is suspended in the air. In some embodiments, data of the flight-restriction zone may be configured in the UAV in advance. In some embodiments, data of the flight-restriction zone may be obtained by the UAV via a network, such as a 4G network or the Internet.

In some embodiments, the first flight state may refer to a current flight state of the UAV during the flight. The first flight state may be considered as, for example, a corresponding flight state of the UAV when the processor of the UAV performs S102.

In some embodiments, the first flight state of the UAV may be determined according to the position of the ground device, i.e., the first position, and the flight-restriction zone. Since the flight-restriction zone may include a no-flight zone and a height-restriction zone, a relationship between the first position and the flight-restriction zone may include: an in-no-flight-zone position, an outside-no-flight-zone position, an in-height-restriction-zone position, an outside-height-restriction-zone position, and/or an unknown position.

For example, if the first position is in a no-flight zone, i.e., is an in-no-flight-zone position, and if the UAV takes off or continues to fly, flight safety of the UAV or other aircraft may be affected. Thus, it may be determined that the first flight state of the UAV is a confirmed-dangerous state.

In S103, a scene of the UAV and a flight strategy corresponding to the scene are determined according to the first flight state of the UAV.

In some embodiments, the scene of the UAV may be determined according to a correspondence relationship between first flight states and scenes. For example, when it is determined that the first flight state is a confirmed-dangerous state, it may be determined that the UAV is in a confirmed-in-no-flight-zone scene.

Further, a corresponding flight strategy may be determined according to the scene of the UAV. For example, if the scene of the UAV is the confirmed-in-no-flight-zone scene, the flight strategy corresponding to the scene may be controlling the UAV to prohibit take-off or to perform forced landing, so as to protect the flight safety of the UAV and other aircraft.

It should be understood that scenes of the UAV and flight strategies corresponding to those scenes may be configured according to various application scenarios, which is not limited in the present disclosure.

It should be understood that, in the present disclosure, detailed descriptions are made for the process of determining the first flight state according to a position of a ground device, and S102 and S103 can be configured according to various application scenarios. It should be understood that, S101, S102, and S103 may be performed individually. For example, in S102, the scene of the UAV may be determined when the first flight state is obtained. Further, in S103, a flight strategy of the UAV may be determined when the scene of the UAV is obtained. Each process, such as S101, S102 or S103, may be configured individually according to various application scenarios, which is not limited in the present disclosure.

In the present disclosure, a position of a ground device with higher accuracy than a UAV may be used to determine a first flight state of the UAV, a scene of the UAV, and a strategy corresponding to the scene, so as to prevent the issue of a UAV entering a flight-restriction zone when a positioning device of the UAV is disturbed, and improve flight safety of UAV and other aircraft. Because position accuracy of the ground device is higher, the resulting scene and corresponding strategy may be more accurate, improving control accuracy, preventing the UAV from being lost or crashed, and improving user flight experience.

If the first position is an outside-no-flight-zone position, an in-height-restriction-zone position, an outside-height-restriction-zone position, and/or an unknown position, UAV may be controlled according to a configured flight strategy. However, in some instance, when a position of the UAV is not determined, a first flight state of the UAV may not be determined. Directed to solving such issues, the present disclosure provides a method for determining a flight strategy of a UAV. The method combines a position of a ground device, i.e., a first position, and a position of a UAV to determine a first flight state. FIG. 2 illustrates a flowchart of a method for determining a flight strategy of a UAV according to various embodiments of the present disclosure. Referring to FIG. 2, the method includes S201 to S203.

In S201, a position of a ground device communicating with the UAV and a position of the UAV are determined.

For determining the position of the ground device, i.e., a first position, references can be made to the relevant descriptions of the present disclosure, such as descriptions associated with S101 and FIG. 1, which are not repeated here.

In some embodiments, the UAV may obtain the position of the UAV, hereinafter referred to as a “second position,” from a positioning device. The positioning device may include, for example, one or more of a global navigation satellite system (GNSS) receiver, a global positioning system (GPS) receiver, a BeiDou navigation satellite system receiver, a Galileo satellite navigation system receiver, a global navigation satellite system (GLONASS) receiver, and/or an automatic dependent surveillance-broadcast (ADS-B) device. Those skilled in the art can make selections according to actual application scenarios, which are not limited in the present disclosure, and fall within the scope of present disclosure.

It should be understood that, the order of determining the first position and the second position by the UAV is not limited. In some embodiments, one of the first and second positions may be determined before the other one of the first and second positions according to various application scenarios. In some embodiments, the first and second positions may be determined at the same time. In the present disclosure, the order of determining the first position and the second position is not limited.

In S202, a first flight state of the UAV is determined according to the position of the ground device, the position of the UAV, and the flight-restriction zone.

In some embodiments, a relationship between the first position and the flight-restriction zone may include at least one of: an in-no-flight-zone position, an outside-no-flight-zone position, an in-height-restriction-zone position, an outside-height-restriction-zone position, or an unknown position. A relationship between the second position and the flight-restriction zone may include at least one of: an in-no-flight-zone position, an outside-no-flight-zone position, an in-height-restriction-zone position, an outside-height-restriction-zone position, or an unknown position. Several relationships between the first position, the second position, and the flight-restriction zone are described merely for illustrative purposes, and are not intended to limit the scope of the present disclosure. It should be understood that if regions included in the flight-restriction zone are changed, the relationships may change accordingly. The relationships may be configured according to various application scenarios, and are not limited in the present disclosure.

In some embodiments, a first flight state of the UAV may be determined according to the above-describe relationships. To reduce calculation amount and simplify descriptions, as an example, the first flight state may include a confirmed-dangerous state, a safe state, a safe-and-height-restriction state, a partially-safe state, a partially-safe-and-height-restriction state, and an unknown state. Only some first flight states are introduced, which are merely for illustrative purposes and are not intended to limit the scope of the present disclosure. If the relationships between the first position, the second position, and the flight-restriction zone change, the number and definition of the first flight states can be adjusted accordingly.

Further, for the relationships between the first position, the second position, and the first flight state, references can be made to Table 1.

TABLE 1
Determine the first flight state according to the first position,
the second position, and the flight-restriction zone

| | Second Position | | | |
|---|---|---|---|---|
| | In- | In-Height- | Outside- | |
| | No-Flight- | Restriction- | No-Flight- | |
| First | Zone | Zone | Zone | Unknown |
| Position | Position | Position | Position | Position |
| In-No-Flight- | Confirmed-Dangerous State | | | |
| Zone Position | | | | |
| In-Height- | Confirmed- | Safe-And- | Safe | Partially-Safe- |
| Restriction- | Dangerous | Height- | State | And-Height- |
| Zone Position | State | Restriction | | Restriction State |
| Outside-No- | | State | | Partially-Safe |
| Flight-Zone | | | | State |
| Position | | | | |
| Unknown Position | | | | Unknown State |

A first column in Table 1 indicates relationships between the first position and the flight-restriction zone. In a first row of the first column, a first position is used to indicate an attribute of the first column. A first row in Table 1 indicates relationships between the second position and the flight-restriction zone. In a first column of the first row, a second position is used to indicate an attribute of the first row. The cells surrounded by the first row and the first column correspond to the first flight state.

According to Table 1, if the first position is in a no-flight zone, i.e., if the first position is an in-no-flight-zone position, regardless of what position the second position is, it is determined that the first flight state is a confirmed-dangerous state.

If the second position is in a no-flight zone, regardless of what position the first position is, it is determined that the first flight state is a confirmed-dangerous state.

If the first position is in a height-restriction zone, i.e., is an in-height-restriction-zone position, and if the second position is in a height-restriction zone, it is determined that the first flight state is a safe-and height-restriction state.

If the first position is outside the no-flight zone, i.e., is in an outside-no-flight-zone position, and if the second position is in the height-restriction zone, it is determined that the first flight state is a safe-and-height-restriction state.

If the first position is an unknown position, and if the second position is in the height-restriction zone, it is determined that the first flight state is a safe-and-height-restriction state.

If the first position is in the height-restriction zone, and if the second position is outside the no-flight zone, it is determined that the first flight state is a safe state.

If the first position is outside the no-flight zone, and if the second position is outside the no-flight zone, it is determined that the first flight state is a safe state.

If the first position is an unknown position, and if the second position is outside the no-flight zone, it is determined that the first flight state is a safe state.

If the first position is in the height-restriction zone, and if the second position is an unknown position, it is determined that the first flight state is a partially-safe-and-height-restriction state.

If the first position is outside the no-flight zone, and if the second position is an unknown position, it is determined that the first flight state is a partially-Safe state.

If the first position is an unknown position, and if the second position is an unknown position, it is determined that the first flight state is an unknown state.

In the present disclosure, the first flight state of the UAV may be determined more accurately by combining the first position and the second position, and further, the determined first flight state can more comprehensively represent an actual flight situation of the UAV, improving control accuracy.

In S203, a scene of the UAV and a flight strategy corresponding to the scene are determined according to the first flight state of the UAV.

In some embodiments, when the first flight state is, for example, a confirmed-dangerous state, a safe state, or a safe-and-height-restriction state, the scene of the UAV and the flight strategy corresponding to the scene may be directly determined.

In some embodiments, if the first flight state is a confirmed-dangerous state, it may be determined that the UAV is in a confirmed-in-no-flight-zone scene.

Accordingly, a flight strategy corresponding to the confirmed-in-no-flight-zone scene may include controlling the UAV to prohibit take-off or perform forced landing.

In some embodiments, if the first flight state is a safe state, it may be determined that the UAV is in a confirmed-outside-no-flight-zone scene.

Accordingly, a flight strategy corresponding to the confirmed-outside-no-flight-zone scene may include maintain the flight state of the UAV. That is, there are no restrictions applied to the UAV.

In some embodiments, if the first flight state is a safe-and-height-restriction state, it may be determined that the UAV is in a confirmed-in-height-restriction-zone scene.

Accordingly, a flight strategy corresponding to the confirmed-in-height-restriction-zone scene may include controlling the UAV to fly at a first preset height, where the first preset height is a height configured in the height-restriction zone.

In a scenario that the first flight state is a partially-safe state, a partially-safe-and-height-restriction state, or an unknown state, a corresponding preset scene may be determined according to the first flight state, and further the UAV may be controlled according to a flight strategy corresponding to the preset scene.

In the present disclosure, descriptions are made for various processes, such as S101, S102, and S103. The processes, such as S101, S102, and S103, may be performed individually. For example, in S102, the scene of the UAV may be determined when the first flight state is obtained. In S103, a flight strategy of the UAV may be determined when the scene of the UAV is obtained. Each process, such as S101, S102 or S103, may be configured individually according to various application scenarios, which is not limited in the present disclosure. In the present disclosure, descriptions are made for various processes, such as S201, S202, and S203. The processes, such as S201, S202, and S203, may be performed individually. For example, in S202, the scene of the UAV may be determined when the first flight state is obtained. In S203, a flight strategy of the UAV may be determined when the scene of the UAV is obtained. Each process, such as S201, S202 or S203, may be configured individually according to various application scenarios, which is not limited in the present disclosure.

In the present disclosure, by combining a position of a ground device with higher accuracy and a position of the UAV to determine the first flight states of the UAV, the number of the first flight states can be increased, and actual flight states of the UAV may be represented more comprehensively. Further, by using the first flight states, a plurality of definite scenes that the UAV may be in can be determined, and further, and the UAV may be controlled according to a flight strategy corresponding to the scene. Accordingly, the UAV may be controlled according to the definite scene and the flight strategy, so as to improve control accuracy, prevent issues of UAV entering the flight-restriction zone because a positioning device of the UAV is interfered, and improve flight safety of the UAV and other aircraft.

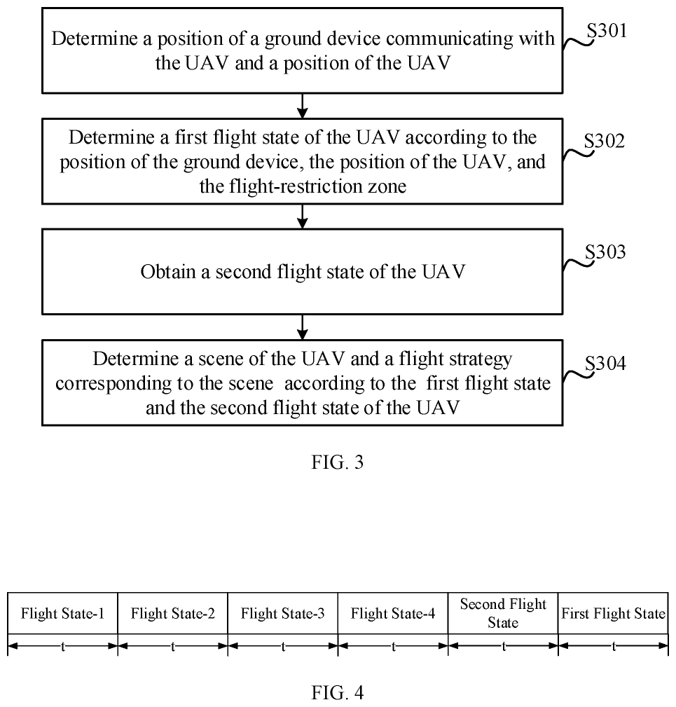

In a scenario that the first flight state is a partially-safe state, a partial-safe-and-height-restriction state or an unknown state, since the corresponding UAV position is unknown, if a preset flight strategy is used, the UAV may still encounter unexpected situations. Thus, the present disclosure further provides a method for determining a UAV flight strategy by combining the first flight state and a preceding flight state, hereinafter referred to as a “second flight state.” Because a UAV has limited speed, a correlation between the first flight state and the second flight state is large, and thus possibility of a sudden change in the scene of the UAV is relatively small. Thus, the scene of the UAV may be accurately determined by using the first flight state and the second flight state, so as to achieve the purposes of solving the above-described technical issues. FIG. 3 illustrates a flowchart of a method for determining a flight strategy of a UAV according to various embodiments of the present disclosure. Referring to FIG. 3, the method may include, for example, S301 to S304.

In S301, a position of a ground device communicating with the UAV and a position of the UAV are determined.

Implementations and principles of S301 and S201 are the same or similar. For details of S301, references can be made to above descriptions, such as descriptions associated with FIG. 2 and/or S201, which are not repeated here.

In S302, a first flight state of the UAV is determined according to the position of the ground device, the position of the UAV, and the flight-restriction zone.

Implementations and principles of S302 and S202 are the same or similar. For details of S302, references can be made to above descriptions, such as descriptions associated with FIG. 2 and/or S202, which are not repeated here.

In S303, a second flight state of the UAV is obtained.

In some embodiments, the second flight state may refer to a flight state that is firstly prior to a corresponding state during the flight of the UAV, e.g., a flight state that is prior to and most close to the corresponding state during the flight of the UAV. That is, the UAV may switch from a second flight state to a first flight state. For example, referring to FIG. 4, the UAV may switch from a flight state-1 to a flight state-2, a flight state-3, a flight state-4, a second flight state, and a first flight state in sequence, and the UAV is currently in the first flight state.

It should be understood, as the flight state of the UAV switches, the above-described first and second flight states may keep changing. In some embodiments, flight states of the UAV may be stored in, for example, a memory, and the flight states, such as the second flight state, may be directly read when the flight states are needed.

In S304, a scene of the UAV and a flight strategy corresponding to the scene are determined according to the first flight state and the second flight state of the UAV.

In some embodiments, the first flight state may include a confirmed-dangerous state, a safe state, a safe-and-height-restriction state, a partially-safe state, a partially-safe-and-height-restriction state, and/or an unknown state. Since the second flight state is a previous state of the UAV, the first flight state may include a confirmed-dangerous state, a safe state, a safe-and-height-restriction state, a partially-safe state, a partially-safe-and-height-restriction state, and/or an unknown state.

To reduce calculation amount and simplify descriptions, in some embodiments, the scene of the UAV may include, for example, at least one of: a confirmed-in-no-flight-zone (CINFZ) scene, a suspected-in-no-flight-zone-lost-satellite-signal (SINFZLSS) scene, a confirmed-in-height-restriction-zone (CIHRZ) scene, a suspected-in-height-restriction-zone-lost-satellite-signal (SIHRZLSS) scene, a confirmed-outside-no-flight-zone (CONFZ) scene, or a lost-satellite-signal (LSS) scene.

Refer to Table 2 for the relationship among the first flight state, the second flight state, and the scene.

TABLE 2
Relationship among the first and second flight states and the scene

| | Second Flight State | | | | | |
|---|---|---|---|---|---|---|
| First | | | Partially-Safe- | | Safe-And- | |
| Flight | Confirmed- | Unknown | And-Height- | Partially- | Height- | Safe |
| State | Dangerous | State | Restriction | Safe | Restriction | State |
| Confirmed- | Confirmed-In-No-Flight-Zone | | | | | |
| Dangerous | | | | | | |
| Unknown | Suspected-In- | Lost- | Suspected- | Lost- | Suspected- | Lost- |
| State | No-Flight- | Satellite- | In-Height- | Satellite- | In-Height- | Satellite- |
| Partially- | Zone-Lost- | Signal | Restriction- | Signal | Restriction- | Signal |
| Safe-And- | Satellite-Signal | | Zone-Lost- | | Zone-Lost- | |
| Height- | | | Satellite- | | Satellite- | |
| Restriction | | | Signal | | Signal | |

| | |
|---|---|
| Partially-Safe | Suspected-In-Height-Restriction-Zone-Lost- Satellite-Signal |

| | |
|---|---|
| Safe-And- | Confirmed-In-Height-Restriction-Zone |
| Height- | |
| Restriction | |
| Safe State | Confirmed-Outside-Height-Restriction-Zone |

In Table 2, a first column indicates the first flight state of the UAV, and a first row indicates the second flight state of the UAV, and the region surrounded by the first column and the first row corresponds to the scene of the UAV.

Referring to Table 2, if the first flight state is a confirmed-dangerous state, regardless of what state the second flight state is, e.g., a confirmed-dangerous state, a safe state, a safe-and-height-restriction state, a partially-safe state, a partially-safe-and-height-restriction state, or an unknown state, it may be determined that the UAV is in a confirmed-in-no-flight-zone scene.

If the first flight state is a safe-and-height-restriction state, regardless of what state the second flight state is, e.g., a confirmed-dangerous state, a safe state, a safe-and-height-restriction state, a partially-safe state, a partially-safe-and-height-restriction state, or an unknown state, it may be determined that the UAV is in a confirmed-in-height-restriction-zone scene.

If the first flight state is a confirmed-safe state, i.e., a safe state, regardless of what state the second flight state is, e.g., a confirmed-dangerous state, a safe state, a safe-and-height-restriction state, a partially-safe state, a partially-safe-and-height-restriction state, or an unknown state, it may be determined that the UAV is in a confirmed-outside-no-flight-zone scene.

If the first flight state is an unknown state, and if the second flight state is a confirmed-dangerous state, it may be determined that the UAV is in a suspected-in-no-flight-zone-lost-satellite-signal scene.

If the first flight state is a partially-safe-and-height-restriction state, and if the second flight state is a confirmed-dangerous state, it may be determined that the UAV is in a suspected-in-no-flight-zone-lost-satellite-signal scene.

If the first flight state is a partially-safe state, and if the second flight state is a confirmed-dangerous state, it may be determined that the UAV is in a suspected-in-no-flighting-zone-lost-satellite-signal scene.

If the first flight state is an unknown state, and if the second flight state is an unknown state, it may be determined that the UAV is in a lost-satellite-signal scene.

If the first flight state is a partially-safe-and-height-restriction state, and if the second flight state is an unknown state, it may be determined that the UAV is in a lost-satellite-signal scene.

If the first flight state is an unknown state, and if the second flight state is a partially-safe-and-height-restriction state, it may be determined that the UAV is in a suspected-in-height-restriction-zone-lost-satellite-signal scene.

If the first flight state is a partially-safe-and-height-restriction state, and if the second flight state is a partially-safe-and-height-restriction state, it may be determined that the UAV is in a lost-satellite-signal scene.

If the first flight state is an unknown state, and if the second flight state is a partially-safe state, it may be determined that the UAV is in a lost-satellite-signal scene.

If the first flight state is a partially-safe-and-height-restriction state, and if the second flight state is a partially-safe state, it may be determined that the UAV is in a lost-satellite-signal scene.

If the first flight state is an unknown state, and if the second flight state is a safe-and-height-restriction state, it may be determined that the UAV is in a suspected-in-height-restriction-zone-lost-satellite-signal scene.

If the first flight state is partially-safe-and-height-restriction state, and if the second flight state is safe-and-height-restriction state, it may be determined that the UAV is in a suspected-in-height-restriction-zone-lost-satellite-signal scene.

If the first flight state is an unknown state, and if the second flight state is a safe state, it may be determined that the UAV is in a lost-satellite-signal scene.

If the first flight state is a partially-safe-and-height-restriction state, and if the second flight state is a safe state, it may be determined that the UAV is in a lost-satellite-signal scene.

If the first flight state is a partially-safe state, and if the second flight state is an unknown state, a partially-safe-and-height-restriction state, a partially-safe state, a safe-and-height-restriction state, or a safe state, it may be determined that the UAV is in a suspected-in-height-restriction-zone-lost-satellite-signal scene.

In some embodiments, the scene of the UAV may be determined, and further a flight strategy of the UAV corresponding to the scene may be determined. Table 3 shows exemplary scenes and corresponding flight strategies consistent with various embodiments of the present disclosure.

TABLE 3
Relationship between scenes and flight strategies

| Scene of UAV | Flight Strategy |
|---|---|
| Confirmed-In-No-Flight-Zone | UAV prohibits take-off; if |
| Suspected-In-No-Flight-Zone- | the UAV already flies, the |
| Lost-Satellite-Signal | UAV preforms forced landing |
| Confirmed-In-Height- | UAV is controlled to fly at a |
| Restriction-Zone | first preset height |
| Suspected-In-Height-Restriction- | |
| Zone-Lost-Satellite-Signal | |
| Confirmed-Outside-Height- | No restriction, UAV flies |
| Restriction-Zone | according to a received |
| | preset instruction |
| Lost-Satellite-Signal | UAV is controlled to fly at a |
| | second preset height |

In some embodiments, if the UAV is in a confirmed-in-no-flight-zone scene or a suspected-in-no-flight-zone-lost-satellite-signal scene, the UAV may be controlled to prohibit take-off or perform forced landing.

In some embodiments, if the UAV is in a confirmed-in-height-restriction-zone scene or a suspected-in-height-restriction-zone-lost-satellite-signal scene, the UAV may be controlled to fly at a first preset height. The first preset height may be, for example, a height of the height-restriction zone.

In some embodiments, if the UAV is in a confirmed-outside-no-flight-zone scene, no restriction is applied to the UAV, i.e., the UAV flies according to a received preset instruction. In some embodiments, if the UAV is in a lost-satellite-signal scene, the UAV may be controlled to fly at a second preset height. The second preset height may be configured in the UAV in advance, and may be, for example, approximately 50 meters.

The descriptions of exemplary flight strategies of the UAV corresponding to above-described six scenes in Table 3 are merely for illustrative purposes, and are not intended to limit the scope of the present disclosure. According to actual applications, the number of scenes may can be appropriately increased or decreased, and flight strategies may be appropriately added or removed, and correspondence relationships between scenes and flight strategies may be adjusted accordingly, which can be configured according to various application scenarios by those skilled in the art, and are not limited in the present disclosure.

In the present disclosure, descriptions are made for various processes, such as S101, S102, and S103. The processes, such as S101, S102, and S103, may be performed individually. For example, in S102, the scene of the UAV may be determined when the first flight state is obtained. In S103, a flight strategy of the UAV may be determined when the scene of the UAV obtained. Each process, such as S101, S102 or S103, may be configured individually according to various application scenarios, which is not limited in the present disclosure. In the present disclosure, descriptions are made for various processes, such as S301, S302, S303, and S304. The processes, such as S301, S302, S303, and S304, may be performed individually. For example, in S303, in response to that the second flight state is obtained, the scene of the UAV may be determined according to the first and second flight states. In S304, a flight strategy of the UAV may be determined when the scene of the UAV obtained. Each process, such as S101, S102, S103 or S104, may be configured individually according to various application scenarios, which is not limited in the present disclosure.

In the present disclosure, by using a position of a ground device and a position of the UAV to determine the first flight state of the UAV, more types of the first flight states may be determined. Further, the scene of the UAV may be determined according to both the first flight state and the second flight state, so as to more comprehensively represent scenes of the UAV, and prevent issues that the scene cannot be determined when the positioning device is disturbed. UAV may be controlled according to the definite scene and flight strategy, so as to improve control accuracy, prevent issues that the UAV enters a flight-restriction zone because a positioning device of the UAV is interfered, and improve flight safety of the UAV and other aircraft. Further, according to the present disclosure, a UAV may be prevented from being lost or crashed, improving user flight experience.

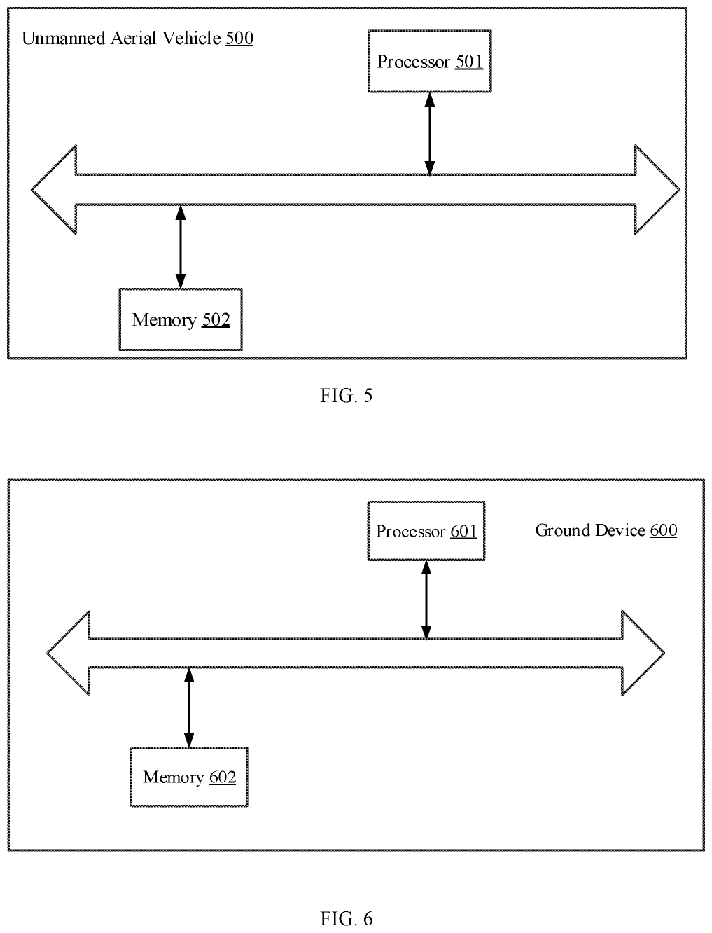

FIG. 5 illustrates a schematic structural diagram of a UAV according to various embodiments of the present disclosure. Referring to FIG. 5, the UAV 500 may include a processor 501, e.g., a hardware processor, and a memory 502. One or more instructions may be stored in the memory 502, and the processor 501 may be configured to read the instructions from the memory 502 and execute the instructions to perform: determining a position of a ground device communicating with the UAV; determining a first flight state of the UAV according to the position of the ground device and a flight-restriction zone; and determining a scene of the UAV and a flight strategy corresponding to the scene according to the first flight state of the UAV.

In some embodiments, determining the first flight state of the UAV, by the processor 501, according to the position of the ground device and the flight-restriction zone may include: if the position of the ground device is in a no-flight zone, determining that the first flight state of the UAV is a confirmed-dangerous state.

In some embodiments, determining the first flight state of the UAV, by the processor 501, according to the position of the ground device and the flight-restriction zone may include: obtaining a position of the UAV; and determining the first flight state of the UAV according to the position of the ground device, the position of the UAV, and the flight-restriction zone.

In some embodiments, determining the first flight state of the UAV, by the processor 501, according to the position of the ground device, the position of the UAV, and the flight-restriction zone may include: if the position of the ground device and the position of the UAV are outside the no-flight zone, controlling the UAV to fly according to a received preset instruction.

In some embodiments, the scene of the UAV may include at least one of a confirmed-in-no-flight-zone scene, a suspected-in-no-flight-zone-lost-satellite-signal scene, a confirmed-in-height-restriction-zone scene, a suspected-in-height-restriction-zone-lost-satellite-signal scene, a confirmed-outside-no-flight-zone scene, or a lost-satellite-signal scene.

In some embodiments, determining the scene of the UAV, by the processor 501, according to the first flight state of the UAV may include: if the first flight state is a confirmed-dangerous state, determining that the UAV is in a confirmed-in-no-flight-zone scene.

In some embodiments, determining the scene of the UAV and the flight strategy corresponding to the scene, by the processor 501, according to the first flight state of the UAV may include: if the UAV is in a confirmed-in-no-flight-zone scene, controlling the UAV to prohibit take-off or perform forced landing.

In some embodiments, determining the scene of the UAV and the flight strategy corresponding to the scene, by the processor 501, according to the first flight state of the UAV may include: if the first flight state is a safe-and-height-restriction state, determining that the UAV is in a confirmed-in-height-restriction-zone scene.

In some embodiments, determining the scene of the UAV and the flight strategy corresponding to the scene, by the processor 501, according to the first flight state of the UAV may include: if the UAV is in a confirmed-in-height-restriction-zone scene, controlling the UAV to fly at a first preset height, where the first preset height may be a height configured in the height-restriction zone.

In some embodiments, determining the scene of the UAV and the flight strategy corresponding to the scene, by the processor 501, according to the first flight state of the UAV may include: if the first flight state is a safe state, determining that the UAV is in a confirmed-outside-no-flight-zone scene.

In some embodiments, the processor 501 may determine a scene of the UAV and a flight strategy corresponding to the scene according to a first flight state of the UAV.

If the UAV is in a confirmed-outside-no-flight-zone scene, the processor 501 may control the UAV to fly according to a received preset instruction.

In some embodiments, determining the scene of the UAV and the flight strategy corresponding to the scene, by the processor 501, according to the first flight state of the UAV may include: obtaining a second flight state of the UAV; and determining the scene of the UAV and the flight strategy corresponding to the scene according to the first flight state and the second flight state of the UAV.

In some embodiments, determining the scene of the UAV, by the processor 501, according to the first flight state and the second flight state of the UAV may include: if the second flight state is an unknown state, and if the first flight state is an unknown state, determining that the UAV is in a lost-satellite-signal scene.

In some embodiments, determining the scene of the UAV, by the processor 501, according to the first flight state and the second flight state of the UAV may include: if the second flight state is a partially-safe state, and if the first flight state is an unknown state, determining that the UAV is in a lost-satellite-signal scene.

In some embodiments, determining the scene of the UAV, by the processor 501, according to the first flight state and the second flight state of the UAV may include: if the second flight state is a safe state, and if the first flight state is an unknown state, determining that the UAV is in a lost-satellite-signal scene.

In some embodiments, determining the scene of the UAV, by the processor 501, according to the first flight state and the second flight state of the UAV may include: if the second flight state is an unknown state, and if the first flight state is a partially-safe-and-height-restriction state, determining that the UAV is in a lost-satellite-signal scene.

In some embodiments, determining the scene of the UAV, by the processor 501, according to the first flight state and the second flight state of the UAV may include: if the second flight state is a partially-safe state, and if the first flight state is a partially-safe-and-height-restriction state, determining that the UAV is in a lost-satellite-signal scene.

In some embodiments, determining the scene of the UAV, by the processor 501, according to the first flight state and the second flight state of the UAV may include: if the second flight state is a safe state, and if the first flight state is a partially-safe-and-height-restriction state, determining that the UAV is in a lost-satellite-signal scene.

In some embodiments, determining the scene of the UAV and the flight strategy corresponding to the scene, by the processor 501, according to the first flight state of the UAV may include: if the UAV is in the lost-satellite-signal scene, controlling the UAV to fly at a second preset height, where the second preset height may be configured in the UAV in advance.

In some embodiments, determining the scene of the UAV, by the processor 501, according to the first flight state and the second flight state of the UAV may include: if the second flight state is a partially-safe-and-height-restriction state, and if the first flight state is an unknown state, determining that the UAV is in a suspected-in-height-restriction-zone-lost-satellite-signal zone.

In some embodiments, determining the scene of the UAV, by the processor 501, according to the first flight state and the second flight state of the UAV may include: if the second flight state is a safe-and-height-restriction state, and if the first flight state is an unknown state, determining that the UAV is in a suspected-in-height-restriction-zone-lost-satellite-signal zone.

In some embodiments, determining the scene of the UAV, by the processor 501, according to the first flight state and the second flight state of the UAV may include: if the second flight state is a partially-safe-and-height-restriction state, and if the first flight state is a safe-and-height-restriction state, determining that the UAV is in a suspected-in-height-restriction-zone-lost-satellite-signal scene.

In some embodiments, determining the scene of the UAV, by the processor 501, according to the first flight state and the second flight state of the UAV may include: if the second flight state is a partially-safe-and-height-restriction state, and if the first flight state is a safe-and-height-restriction state, determining that the UAV is in a suspected-in-height-restriction-zone-lost-satellite-signal scene.

In some embodiments, determining the scene of the UAV, by the processor 501, according to the first flight state and the second flight state of the UAV may include: if the second flight state is an unknown state, and if the first flight state is a partially-safe state, determining that the UAV is in a suspected-in-height-restriction-zone-lost-satellite-signal scene.

In some embodiments, determining the scene of the UAV, by the processor 501, according to the first flight state and the second flight state of the UAV may include: if the second flight state is a partially-safe-and-height-restriction state, and if the first flight state is a partially-safe state, determining that the UAV is in a suspected-in-height-restriction-zone-lost-satellite-signal scene.

In some embodiments, determining the scene of the UAV, by the processor 501, according to the first flight state and the second flight state of the UAV may include: if the second flight state is a partially-safe state, and if the first flight state is a partially-safe state, determining that the UAV is in a suspected-in-height-restriction-zone-lost-satellite-signal scene.

In some embodiments, determining the scene of the UAV, by the processor 501, according to the first flight state and the second flight state of the UAV may include: if the second flight state is a safe-and-height-restriction state, and if the first flight state is a partially-safe state, determining that the UAV is in a suspected-in-height-restriction-zone-lost-satellite-signal scene.

In some embodiments, determining the scene of the UAV, by the processor 501, according to the first flight state and the second flight state of the UAV may include: if the second flight state is a safe state, and if the first flight state is a partially-safe state, determining that the UAV is in a suspected-in-height-restriction-zone-lost-satellite-signal scene.

In some embodiments, determining the scene of the UAV and the flight strategy corresponding to the scene, by the processor 501, according to the first flight state and the second flight state of the UAV may include: if the UAV is in a suspected-in-height-restriction-zone-lost-satellite-signal scene, controlling the UAV to fly at a first preset height, where the first preset height may be a height configured in the height-restriction zone.

In some embodiments, determining the scene of the UAV, by the processor 501, according to the first flight state and the second flight state of the UAV may include: if the second flight state is a confirmed-dangerous state, and if the first flight state is an unknown state, determining that the UAV is in a suspected-in-no-flight-zone-lost-satellite-signal scene.

In some embodiments, determining the scene of the UAV, by the processor 501, according to the first flight state and the second flight state of the UAV may include: if the second flight state is a confirmed-dangerous state, and if the first flight state is a partially-safe-and-height-restriction state, determining that the UAV is in a suspected-in-no-flight-zone-lost-satellite-signal scene.

In some embodiments, determining the scene of the UAV, by the processor 501, according to the first flight state and the second flight state of the UAV may include: if the second flight state is a confirmed-dangerous state, and if the first flight state is a partially-safe state, determining that the UAV is in a suspected-in-no-flight-zone-lost-satellite-signal scene.

In some embodiments, determining the scene of the UAV and the flight strategy corresponding to the scene, by the processor 501, according to the first flight state and the second flight state of the UAV may include: if the UAV is in a suspected-in-no-flight-zone-lost-satellite-signal scene, controlling the UAV to prohibit take-off or perform forced landing.

In some embodiments, the processor 501 may be further configured to: if the UAV is in a confirmed-in-no-flight-zone scene, generate prompt information for instructing a user to leave the no-flight zone, and send the prompt information to the ground device.

In some embodiments, the processor 501 may be further configured to: if the UAV is in a suspected-in-no-flight-zone-lost-satellite-signal scene, generate prompt information for instructing the user to leave the no-flight zone, and send the prompt information to the ground device.

In some embodiments, the processor 501 may be further configured to: if the UAV is in a confirmed-in-height-restriction-zone scene, generate prompt information for instructing the user to pay attention to a flight height, and send the prompt information to the ground device.

In some embodiments, the processor 501 may be further configured to: if the UAV is in a suspected-in-height-restriction-zone-lost-satellite-signal scene, generate prompt information for instructing the user to pay attention to a flight height, and send the prompt information to the ground device.

In some embodiments, the processor 501 may be further configured to: if the UAV is in a lost-satellite-signal scene, generate prompt information for instructing the user to pay attention to the loss of the satellite signal and to pay attention to the flight, and send the prompt information to the ground device.

In some embodiments, the ground device may include, for example, a control-terminal device or a terminal device having an APP for controlling a UAV.

FIG. 6 illustrates a schematic structural diagram of a ground device according to various embodiments of the present disclosure. Referring to FIG. 6, the ground device 600 includes a processor 601, e.g., a hardware processor, and a memory 602. The memory 602 may store one or more instructions, and the processor 601 may be configured to read the instructions from the memory 602 and execute the instructions to perform: determining a position of a ground device communicating with the UAV; determining a first flight state of the UAV according to the position of the ground device and a flight-restriction zone; and determining a scene of the UAV and a flight strategy corresponding to the scene according to the first flight state of the UAV; and sending the flight strategy corresponding to the scene of the UAV to the UAV.

In some embodiments, determining the first flight state of the UAV, by the processor 601, according to the position of the ground device and the flight-restriction zone may include: if the position of the ground device is in a no-flight zone, determining, according to the position of the ground device, that the first flight state of the UAV is a confirmed-dangerous state.

In some embodiments, the processor 601 may determine a first flight state of the UAV according to the position of the ground device and the flight-restriction zone, which may include obtaining a position of the UAV; and determining the first flight state of the UAV according to the position of the ground device, the position of the UAV, and the flight-restriction zone.

In some embodiments, determining the first flight state of the UAV, by the processor 601, according to the position of the ground device, the position of the UAV, and the flight-restriction zone may include: if the position of the ground device and the position of the UAV are outside the no-flight zone, controlling the UAV to fly according to a received preset instruction.

In some embodiments, scenes of the UAV may include at least of one: a confirmed-in-no-flight-zone scene, a suspected-in-no-flight-zone-lost-satellite-signal scene, a confirmed-in-height-restriction-zone scene, a suspected-in-height-restriction-zone-lost-satellite-signal scene, a confirmed-outside-no-flight-zone scene, or a lost-satellite-signal.

In some embodiments, determining the scene of the UAV and the flight strategy corresponding to the scene, by the processor 601, according to the first flight state of the UAV may include: if the first flight state is a confirmed-dangerous state, determining that the UAV is in a confirmed-in-no-flight-zone scene.

In some embodiments, determining the scene of the UAV and the flight strategy corresponding to the scene, by the processor 601, according to the first flight state of the UAV may include: if the UAV is in a confirmed-in-no-flight-zone scene, controlling the UAV to prohibit take-off or perform forced landing.

In some embodiments, determining the scene of the UAV, by the processor 601, according to the first flight state of the UAV may include: if the first flight state is a safe-and-height-restriction state, determining that the UAV is in a confirmed-in-height-restriction-zone scene.

In some embodiments, determining the scene of the UAV and the flight strategy corresponding to the scene, by the processor 601, according to the first flight state of the UAV may include: if the UAV is in a confirmed-in-height-restriction-zone scene, controlling the UAV to fly at a first preset height, where the first preset height may be a height configured in the height-restriction zone.

In some embodiments, determining the scene of the UAV and the flight strategy corresponding to the scene, by the processor 601, according to the first flight state of the UAV may include: if the first flight state is a safe state, determining that the UAV is in a confirmed-outside-no-flight-zone scene.

In some embodiments, determining the scene of the UAV and the flight strategy corresponding to the scene, by the processor 601, according to the first flight state of the UAV may include: if the UAV is a confirmed-outside-no-flight-zone scene, controlling the UAV to fly according to a received preset instruction.

In some embodiments, determining the scene of the UAV and the flight strategy corresponding to the scene, by the processor 601, according to the first flight state of the UAV may include: obtaining a second flight state of the UAV; and determining the scene of the UAV and the flight strategy corresponding to the scene according to the first flight state and the second flight state of the UAV.

In some embodiments, determining the scene of the UAV, by the processor 601, according to the first flight state and the second flight state of the UAV may include: if the second flight state is an unknown state, and if the first flight state is an unknown state, determining that the UAV is in a lost-satellite-signal scene.

In some embodiments, determining the scene of the UAV, by the processor 601, according to the first flight state and the second flight state of the UAV may include: if the second flight state is a partially-safe state, and if the first flight state is an unknown state, determining that the UAV is in a lost-satellite-signal scene.

In some embodiments, determining the scene of the UAV, by the processor 601, according to the first flight state and the second flight state of the UAV may include: if the second flight state is a safe state, and if the first flight state is an unknown state, determining that the UAV is in a lost-satellite-signal scene.

In some embodiments, determining the scene of the UAV, by the processor 601, according to the first flight state and the second flight state of the UAV may include: if the second flight state is an unknown state, and if the first flight state is a partially-safe-and-height-restriction state, determining that the UAV is in a lost-satellite-signal scene.

In some embodiments, determining the scene of the UAV, by the processor 601, according to the first flight state and the second flight state of the UAV may include: if the second flight state is a partially-safe state, and if the first flight state is a partially-safe-and-height-restriction state, determining that the UAV is in a lost-satellite-signal scene.

In some embodiments, determining the scene of the UAV, by the processor 601, according to the first flight state and the second flight state of the UAV may include: if the second flight state is a safe state, and if the first flight state is a partially-safe-and-height-restriction state, determining that the UAV is in a lost-satellite-signal scene.

In some embodiments, determining the scene of the UAV and the flight strategy corresponding to the scene, by the processor 601, according to the first flight state of the UAV may include: if the UAV is in a lost-satellite-signal scene, controlling the UAV to fly at a second preset height, where the second preset height may be configured in the UAV in advance.

In some embodiments, determining the scene of the UAV, by the processor 601, according to the first flight state and the second flight state of the UAV may include: if the second flight state is a partially-safe-and-height-restriction state, and if the first flight state is an unknown state, determining that the UAV is in a suspected-in-height-restriction-zone-lost-satellite-signal scene.

In some embodiments, determining the scene of the UAV, by the processor 601, according to the first flight state and the second flight state of the UAV may include: if the second flight state is a safe-and-height-restriction state, and if the first flight state is an unknown state, determining that the UAV is in a suspected-in-height-restriction-zone-lost-satellite-signal scene.

In some embodiments, determining the scene of the UAV, by the processor 601, according to the first flight state and the second flight state of the UAV may include: if the second flight state is a partially-safe-and-height-restriction state, and if the first flight state is a safe-and-height-restriction state, determining that the UAV is in a suspected-in-height-restriction-zone-lost-satellite-signal scene.

In some embodiments, determining the scene of the UAV, by the processor 601, according to the first flight state and the second flight state of the UAV may include: if the second flight state is a partially-safe-and-height-restriction state, and if the first flight state is a safe-and-height-restriction state, determining that the UAV is in a suspected-in-height-restriction-zone-lost-satellite-signal scene.

In some embodiments, determining the scene of the UAV, by the processor 601, according to the first flight state and the second flight state of the UAV may include: if the second flight state is an unknown state, and if the first flight state is a partially-safe state, determining that the UAV is in a suspected-in-height-restriction-zone-lost-satellite-signal scene.

In some embodiments, determining the scene of the UAV, by the processor 601, according to the first flight state and the second flight state of the UAV may include: if the second flight state is a partially-safe-and-height-restriction state, and if the first flight state is a partially-safe state, determining that the UAV is in a suspected-in-height-restriction-zone-lost-satellite-signal scene.

In some embodiments, determining the scene of the UAV, by the processor 601, according to the first flight state and the second flight state of the UAV may include: if the second flight state is a partially-safe state, and if the first flight state is a partially-safe state, determining that the UAV is in a suspected-in-height-restriction-zone-lost-satellite-signal scene.

In some embodiments, determining the scene of the UAV, by the processor 601, according to the first flight state and the second flight state of the UAV may include: if the second flight state is a safe-and-height-restriction state, and if the first flight state is a partially-safe state, determining that the UAV is in a suspected-in-height-restriction-zone-lost-satellite-signal scene.

In some embodiments, determining the scene of the UAV, by the processor 601, according to the first flight state and the second flight state of the UAV may include: if the second flight state is a safe state, and if the first flight state is a partially-safe state, determining that the UAV is in a suspected-in-height-restriction-zone-lost-satellite-signal scene.

In some embodiments, determining the scene of the UAV and the flight strategy corresponding to the scene, by the processor 601, according to the first flight state and the second flight state of the UAV may include: if the UAV is in a suspected-in-height-restriction-zone-lost-satellite-signal scene, controlling the UAV to fly at a first preset height, where the first preset height may be a height configured in the height-restriction zone.

In some embodiments, determining the scene of the UAV, by the processor 601, according to the first flight state and the second flight state of the UAV may include: if the second flight state is a confirmed-dangerous state, and if the first flight state is an unknown state, determining that the UAV is in a suspected-in-no-flight-zone-lost-satellite-signal scene.

In some embodiments, determining the scene of the UAV, by the processor 601, according to the first flight state and the second flight state of the UAV may include: if the second flight state is a confirmed-dangerous state, and if the first flight state is a partially-safe-and-height-restriction state, determining that the UAV is in a suspected-in-no-flight-zone-lost-satellite-signal scene.

In some embodiments, determining the scene of the UAV, by the processor 601, according to the first flight state and the second flight state of the UAV may include: if the second flight state is a confirmed-dangerous state, and if the first flight state is a partially-safe state, determining that the UAV is in a suspected-in-no-flight-zone-lost-satellite-signal scene.

In some embodiments, determining the scene of the UAV and the flight strategy corresponding to the scene, by the processor 601, according to the first flight state and the second flight state of the UAV may include: if the UAV is in the suspected-in-no-flight-zone-lost-satellite-signal scene, controlling the UAV to prohibit take-off or perform forced landing.

In some embodiments, the processor 601 may be further configured to: if the UAV is in a confirmed-in-no-flight-zone scene, generate prompt information for instructing a user to leave the no-flight zone, e.g., generate prompt information for instructing a user to have the UAV to leave the no-flight zone.

In some embodiments, the processor 601 may be further configured to: if the UAV is in a suspected-in-no-flight-zone-lost-satellite-signal scene, generate prompt information for instructing the user to leave the no-flight zone, e.g., generate prompt information for instructing a user to have the UAV to leave the no-flight zone.

In some embodiments, the processor 601 may be further configured to: if the UAV is in a confirmed-in-height-restriction-zone scene, generate prompt information for instructing the user to pay attention to a flight height.

In some embodiments, the processor 601 may be further configured to: if the UAV is in a suspected-in-height-restriction-zone-lost-satellite-signal scene, generate prompt information for instructing the user to pay attention to a flight height.

In some embodiments, the processor 601 may be further configured to: if the UAV is in a confirmed-lost-satellite-signal scene, i.e., a lost-satellite-signal scene, generate prompt information for instructing the user to pay attention to the loss of the satellite signal and to pay attention to the flight.

In some embodiments, the ground device may include, for example, a control-terminal device or a terminal device having an APP for controlling a UAV.

The present disclosure further provides a machine-readable storage medium that stores one or more computer instructions thereon, and the computer instructions may be executed to perform: determining a position of a ground device communicating with the UAV; determining a first flight state of the UAV according to the position of the ground device and a flight-restriction zone; and determining a scene of the UAV and a flight strategy corresponding to the scene according to the first flight state of the UAV.

The present disclosure further provides another machine-readable storage medium that stores one or more computer instructions thereon, and further, the computer instructions may be executed to perform: determining a position of a ground device communicating with the UAV; determining a first flight state of the UAV according to the position of the ground device and a flight-restriction zone; determining a scene of the UAV and a flight strategy corresponding to the scene according to the first flight state of the UAV; and sending the flight strategy corresponding to the scene of the UAV to the UAV.

It should be understood that, in the present disclosure, processing operations of the processor in the UAV are described in detail in above-described method embodiments, and thus, for related descriptions, references can be made to the method embodiments. Further, processing operations of the processor in the ground device are described in detail in above-described method embodiments, and thus, for related descriptions, references can be made to the method embodiments. Further, the above-described methods can vary according to various application scenarios, and the processing operations of the processor in the UAV and/or the ground device can be adjusted accordingly, descriptions of which are not repeated here.

In the present disclosure, a scene of a UAV may be determined according to a position of a ground device, and further a corresponding flight strategy may be performed. Thus, issues of the UAV entering a flight-restriction zone because of a positioning device of the UAV being disturbed may be prevented, and further the UAV may be prevented from being lost and crashed, improving user flight experience.

It should be understood that relational terms such as “first,” “second,” and the like are merely intended to distinguish between similar objects or similar operations but do not necessarily require or indicate an actual relationship or order between the similar objects or similar operations. The terms “include,” “contain,” and/or any other similar expressions are intended to cover non-exclusive inclusion, such that a process, method, article, or device that includes a series of elements includes not only those elements that are explicitly listed, but also other elements not explicitly listed and/or elements that are inherent to such a process, method, article, or device. Without further restrictions, defining an element by the expression “including an element” or any other similar expressions may not exclude the existence of other identical elements in the process, method, article, or device that includes the element.

Those of ordinary skill in the art will appreciate that the exemplary elements and algorithm steps described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure.

For simplification purposes, detailed descriptions of the operations of exemplary systems, devices, and units may be omitted and references can be made to the descriptions of the exemplary methods.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the exemplary methods described above. The storage medium can be any medium that can store program codes, for example, a USB disk, a mobile hard disk, a read-only memory (ROM), a random access memory (RAM), a magnetic disk, or an optical disk.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A method for determining a flight strategy of an unmanned aerial vehicle, comprising:
determining a position of a ground device communicating with the unmanned aerial vehicle;
determining a first flight state of the unmanned aerial vehicle according to the position of the ground device and a flight-restriction zone; and
determining a scene of the unmanned aerial vehicle and the flight strategy corresponding to the scene according to the first flight state of the unmanned aerial vehicle.

2. The method according to claim 1, wherein determining the first flight state of the unmanned aerial vehicle according to the position of the ground device and the flight-restriction zone includes:
in response to that the position of the ground device is an in-no-flight-zone position, determining that the first flight state of the unmanned aerial vehicle is a confirmed-dangerous state; or
in response to that the position of the ground device is an outside-no-flight-zone position and that a position of the unmanned aerial vehicle is the outside-no-flight-zone position, determining that the first flight state of the unmanned aerial vehicle is a safe state.

3. The method according to claim 1, wherein the scene of the unmanned aerial vehicle includes at least one of:
a confirmed-in-no-flight-zone scene,
a suspected-in-no-flight-zone-lost-satellite-signal scene,
a confirmed-in-height-restriction-zone scene,
a suspected-in-height-restriction-zone-lost-satellite-signal scene,
a confirmed-outside-no-flight-zone scene, or
a lost-satellite-signal scene.

4. The method according to claim 1, wherein determining the scene of the unmanned aerial vehicle according to the first flight state of the unmanned aerial vehicle includes:
in response to that the first flight state is a confirmed-dangerous state, determining that the unmanned aerial vehicle is in a confirmed-in-no-flight-zone scene.

5. The method according to claim 4, wherein determining the scene of the unmanned aerial vehicle and the flight strategy corresponding to the scene according to the first flight state of the unmanned aerial vehicle includes:
in response to that the unmanned aerial vehicle is in the confirmed-in-no-flight-zone scene, controlling the unmanned aerial vehicle to prohibit take-off or perform forced landing.

6. The method according to claim 1, wherein determining the scene of the unmanned aerial vehicle and the flight strategy corresponding to the scene according to the first flight state of the unmanned aerial vehicle includes:
in response to that the first flight state is a safe-and-height-restriction state, determining that the unmanned aerial vehicle is in a confirmed-in-height-restriction-zone scene.

7. The method according to claim 6, wherein determining the scene of the unmanned aerial vehicle and the flight strategy corresponding to the scene according to the first flight state of the unmanned aerial vehicle includes:
in response to that the unmanned aerial vehicle is in the confirmed-in-height-restriction-zone scene, controlling the unmanned aerial vehicle to fly at a first preset height, wherein the first preset height is a height configured in the height-restriction zone.

8. The method according to claim 1, wherein determining the scene of the unmanned aerial vehicle and the flight strategy corresponding to the scene according to the first flight state of the unmanned aerial vehicle includes:
in response to that the first flight state is a safe state, determining that the unmanned aerial vehicle is in a confirmed-outside-no-flight-zone scene.

9. The method according to claim 8, wherein determining the scene of the unmanned aerial vehicle and the flight strategy corresponding to the scene according to the first flight state of the unmanned aerial vehicle includes:
in response to that the unmanned aerial vehicle is the confirmed-in-no-flight-zone scene, controlling the unmanned aerial vehicle to fly according to a received preset instruction.

10. The method according to claim 1, wherein determining the scene of the unmanned aerial vehicle and the flight strategy corresponding to the scene according to the first flight state of the unmanned aerial vehicle includes:
obtaining a second flight state of the unmanned aerial vehicle; and
determining the scene of the unmanned aerial vehicle and the flight strategy corresponding to the scene according to the first flight state and the second flight state of the unmanned aerial vehicle.

11. The method according to claim 10, wherein determining the scene of the unmanned aerial vehicle according to the first flight state and the second flight state of the unmanned aerial vehicle includes:
in response to that the second flight state is an unknown state and that the first flight state is the unknown state, determining that the unmanned aerial vehicle is in a lost-satellite-signal scene;
in response to that the second flight state is a partially-safe state and that the first flight state is the unknown state, determining that the unmanned aerial vehicle is in the lost-satellite-signal scene;
in response to that the second flight state is a safe state and that the first flight state is the unknown state, determining that the unmanned aerial vehicle is in the lost-satellite-signal scene;
in response to that the second flight state is the unknown state and that the first flight state is a partially-safe-and-height-restriction state, determining that the unmanned aerial vehicle is in the lost-satellite-signal scene;
in response to that the second flight state is the partially-safe state and that the first flight state is the partially-safe-and-height-restriction state, determining that the unmanned aerial vehicle is in the lost-satellite-signal scene; or
in response to that the second flight state is the safe state and that the first flight state is the partially-safe-and-height-restriction state, determining that the unmanned aerial vehicle is in the lost-satellite-signal scene.

12. The method according to claim 11, wherein determining the scene of the unmanned aerial vehicle and the flight strategy corresponding to the scene according to the first flight state of the unmanned aerial vehicle includes:
in response to that the unmanned aerial vehicle is in the lost-satellite-signal scene, controlling the unmanned aerial vehicle to fly at a second preset height, wherein the second preset height is configured in the unmanned aerial vehicle in advance.

13. The method according to claim 10, wherein determining the scene of the unmanned aerial vehicle according to the first flight state and the second flight state of the unmanned aerial vehicle includes:
in response to that the second flight state is a partially-safe-and-height-restriction state and that the first flight state is an unknown state, determining that the unmanned aerial vehicle is in a suspected-in-height-restriction-zone-lost-satellite-signal scene;
in response to that the second flight state is a safe-and-height-restriction state and that the first flight state is the unknown state, determining that the unmanned aerial vehicle is in a suspected-in-height-restriction-zone-lost-satellite-signal scene;
in response to that the second flight state is a partially-safe state and that the first flight state is the partially-safe state, determining that the unmanned aerial vehicle is in the suspected-in-height-restriction-zone-lost-satellite-signal scene;
in response to that the second flight state is the safe-and-height-restriction state and that the first flight state is the partially-safe-and-height-restriction state, determining that the unmanned aerial vehicle is in the suspected-in-height-restriction-zone-lost-satellite-signal scene;
in response to that the second flight state is the unknown state and that the first flight state is the partially-safe state, determining that the unmanned aerial vehicle is in the suspected-in-height-restriction-zone-lost-satellite-signal scene;
in response to that the second flight state is the partially-safe-and-height-restriction state and that the first flight state is the partially-safe state, determining that the unmanned aerial vehicle is in a suspected-in-height-restriction-zone-lost-satellite-signal scene;
in response to that the second flight state is the partially-safe state and that the first flight state is the partially-safe state, determining that the unmanned aerial vehicle is in the suspected-in-height-restriction-zone-lost-satellite-signal scene;
in response to that the second flight state is the safe-and-height-restriction state and that the first flight state is the partially-safe state, determining that the unmanned aerial vehicle is in the suspected-in-height-restriction-zone-lost-satellite-signal scene; or
in response to that the second flight state is a safe state and that the first flight state is the partially-safe state, determining that the unmanned aerial vehicle is in the suspected-in-height-restriction-zone-lost-satellite-signal scene.

14. The method according to claims 13, wherein determining the scene of the unmanned aerial vehicle and the flight strategy corresponding to the scene according to the first flight state and the second flight state of the unmanned aerial vehicle includes:
in response to that the unmanned aerial vehicle is in the suspected-in-height-restriction-zone-lost-satellite-signal scene, controlling the unmanned aerial vehicle to fly at a first preset height, wherein the first preset height is a height configured in the height-restriction zone.

15. The method according to claim 10, wherein determining the scene of the unmanned aerial vehicle according to the first flight state and the second flight state of the unmanned aerial vehicle includes:
in response to that the second flight state is a confirmed-dangerous state and that the first flight state is an unknown state, determining that the unmanned aerial vehicle is in a suspected-in-no-flight-zone-lost-satellite-signal scene;
in response to that the second flight state is the confirmed-dangerous state and that the first flight state is a partially-safe-and-height-restriction state, determining that the unmanned aerial vehicle is in the suspected-in-no-flight-zone-lost-satellite-signal scene; or
in response to that the second flight state is the confirmed-dangerous state and that the first flight state is a partially-safe state, determining that the unmanned aerial vehicle is in the suspected-in-no-flight-zone-lost-satellite-signal scene.

16. The method according to claims 15, wherein determining the scene of the unmanned aerial vehicle and the flight strategy corresponding to the scene according to the first flight state and the second flight state of the unmanned aerial vehicle includes:
in response to that the unmanned aerial vehicle is in the suspected-in-no-flight-zone-lost-satellite-signal scene, controlling the unmanned aerial vehicle to prohibit take-off or perform forced landing.

17. The method according to claims 1, further comprising:
in response to that the unmanned aerial vehicle is in a confirmed-in-no-flight-zone scene, generating prompt information for instructing a user to leave a no-flight zone, and sending the prompt information to the ground device;
in response to that the unmanned aerial vehicle is in a suspected-in-no-flight-zone-lost-satellite-signal scene, generating prompt information for instructing the user to leave the no-flight zone, and sending the prompt information to the ground device;
in response to that the unmanned aerial vehicle is in a confirmed-in-height-restriction-zone scene, generating prompt information for instructing the user to pay attention to a flight height, and sending the prompt information to the ground device;
in response to that the unmanned aerial vehicle is in a suspected-in-height-restriction-zone-lost-satellite-signal scene, generating prompt information for instructing the user to pay attention to the flight height, and sending the prompt information to the ground device; or
in response to that the unmanned aerial vehicle is in a lost-satellite-signal scene, generating prompt information for instructing the user to pay attention to loss of a satellite signal and to pay attention to a flight of the UAV, and sending the prompt information to the ground device.

18. The method according to claims 1, further comprising:
sending the flight strategy corresponding to the scene of the unmanned aerial vehicle to the unmanned aerial vehicle.

19. An electronic device, comprising:
a memory for storing one or more instructions; and
a processor configured to read the one or more instructions from the memory and execute the one or more instructions to perform:
determining a position of a ground device communicating with an unmanned aerial vehicle,
determining a first flight state of the unmanned aerial vehicle according to the position of the ground device and a flight-restriction zone, and
determining a scene of the unmanned aerial vehicle and a flight strategy corresponding to the scene according to the first flight state of the unmanned aerial vehicle.

20. The electronic device according to claim 19, wherein determining the first flight state of the unmanned aerial vehicle according to the position of the ground device and the flight-restriction zone by the processor includes:
in response to that the position of the ground device is an in-no-flight-zone position, determining that the first flight state of the unmanned aerial vehicle is a confirmed-dangerous state; or
in response to that the position of the ground device is an outside-no-flight-zone position and that the position of the unmanned aerial vehicle is the outside-no-flight-zone position, determining that the first flight state of the unmanned aerial vehicle is a safe state.
